(19) United States
(12) Patent Application Publication
(10) Pub. No.: US 2012/0205336 A1
(43) Pub. Date: Aug. 16, 2012

(54) CRANE JIB TRANSITION STRUCTURE

(75) Inventors: Fenglin Han, Shanghai (CN); Mingqi Li, Shanghai (CN)

(73) Assignees: KUNSHAN SANY MECHANICAL, CO., LTD., Jiangsu (CN); HUNAN SANY INTELLIGENT CONTROL EQUIPMENT CO., LTD., Changsha (CN)

(21) Appl. No.: 13/318,281

(22) PCT Filed: Jun. 27, 2011
(86) PCT No.: PCT/CN2011/001056

§ 371 Date: Apr. 26, 2012

(30) Foreign Application Priority Data
Jul. 21, 2010 (CN) 201010232241.0

(51) Int. Cl. B66C 23/64

(52) U.S. Cl. 212/347

(57) ABSTRACT

The present invention relates to a crane jib transition structure, mainly including a jib section, a transition section and a supporting structure, wherein, said jib section matches with said transition section, and they fixedly connect to each other, the upper end of said supporting structure fixedly connects to the upper end of the side of said jib section, the bottom end of said supporting structure fixedly connects to the bottom end of the corresponding side of the transition section, the middle part of said supporting structure fixedly connects to the connection point between the side of jib section and the corresponding side of transition section. Therefore, the crane jib transition structure of the present invention can not only achieve the strength of a crane jib transition structure, but also achieve the strength and the overall stability of a crane jib, by using a supporting structure connecting to between the crane jib section and transition section, which have simpler structure, easier installation, lower production cost and can be widely used in various types of cranes.

### FIELD OF INVENTION

The present invention relates to a crane jib, and in particular, relates to a crane jib transition structure.

### BACKGROUND OF INVENTION

Nowadays, the truss jib of a crane is made up of many jib sections. In general the cross-section of the jib section is a rectangle or other polygons. According to the different design requirements for a crane, the cross-section of the jib section is usually different. In order to use the jib sections having different dimensions of the cross-section on the same jib, usually two jib sections having different dimensions of the cross-section are connected each other by using transition section, as shown in FIG. 1 and FIG. 2. However, the above mentioned structure leads to the change of dimensions of the cross-section of the jib, thus it will affect the strength and the overall stability of a crane jib structure, and it will make some security problems of operation of the crane.

### SUMMARY OF THE INVENTION

The purpose of the present invention is to provide a crane jib transition structure, which can achieve direct and stable connection between a crane jib section and a transition section, thereby it can increase the strength and the overall stability of a crane jib structure.

In order to achieve the above purpose, the crane jib transition structure of the present invention, mainly including a jib section, a transition section and a supporting structure, wherein, said jib section matches with said transition section, and they fixedly connect to each other, the upper end of said supporting structure fixedly connects to the upper end of the side of said jib section, the bottom end of said supporting structure fixedly connects to the bottom end of the corresponding side of the transition section, the middle part of said supporting structure fixedly connects to the connection point between the side of jib section and the corresponding side of transition section.

The above mentioned crane jib transition structure, wherein, said supporting structure is a box beam, and one box beam is positioned on each side of the corresponding jib section.

The above-mentioned crane jib transition structure, wherein, said supporting structure is a truss jib, and one truss jib is positioned on each side surface of the corresponding jib section, wherein said side surface is an outer side surface of jib section, including two adjacent sides.

The above mentioned crane jib transition structure, wherein, said truss jib is a trapezoid structure.

The above mentioned crane jib transition structure, wherein, said supporting structure is connected to said jib section by bearing pins or high-strength bolts.

The above mentioned crane jib transition structure, wherein, said supporting structure is connected to the said transition section by bearing pins or high-strength bolts.

The above mentioned crane jib transition structure, wherein, said supporting structure is made up of steel pipe.

The above mentioned crane jib transition structure, wherein, said steel pipe is a seamless steel pipe,

Therefore, the crane jib transition structure of the present invention can not only achieve the strength of a crane jib transition structure, but also achieve the strength and the overall stability of a crane jib, by using a supporting structure connecting to between the crane jib section and transition section, which have simpler structure, easier installation, lower production cost and can be widely used in various types of cranes.

### BRIEF DESCRIPTION OF THE DRAWINGS

FIG. 1 shows a crane jib transition structure of existing technology;

FIG. 2 shows three-dimensional structure of FIG. 1;

FIG. 3 shows the first preferred embodiment of the crane jib transition structure of the present invention;

FIG. 4 shows three-dimensional structure of FIG. 3;

FIG. 5 shows the supporting structure of the first preferred embodiment of the crane jib transition structure of the present invention;

FIG. 6 shows three-dimensional structure of FIG. 5;

FIG. 7 the second preferred embodiment of the crane jib transition structure of the present invention;

FIG. 8 shows three-dimensional structure of FIG. 7;

FIG. 9 shows the supporting structure of the second preferred embodiment of the crane jib transition structure of the present invention;

FIG. 10 shows three-dimensional structure of FIG. 9.

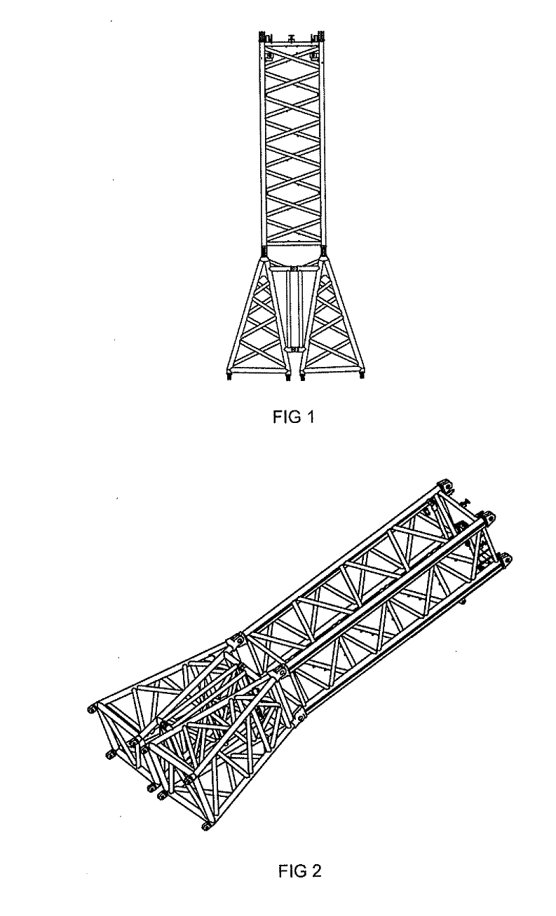

### DETAILED DESCRIPTION OF THE PREFERRED EMBODIMENT

The illustration of the present invention should be made to the following detailed description taken in conjunction with the accompanying drawings:

In general, a crane jib structure is made up of many jib sections. When the jib structures have different dimension need to be connected to each other, a transition section will be used as a connection means between two jib sections. The crane jib transition structure of the present invention can achieve stable connection between a jib section and a transition section, thus it will make the overall jib be operated stability. Wherein, the jib transition structure includes a jib section, a transition section and a supporting structure. Wherein, the jib matches with the transition section, and the end-face of the transition section has the same size with the end-face of the jib section, and they can connect each other. However, the upper end of the supporting structure fixedly connects to the upper end of the side of the jib section, the bottom end of the supporting structure fixedly connects to the bottom end of the corresponding side of the transition section, the middle part of the supporting structure fixedly connects to the connection point between the side of jib section and the corresponding side of transition section. The supporting structure is made up of steel pipe, in particular, seamless steel pipe. In addition, the supporting structure fixedly is connected to the jib section and the transition section by bearing pins or high-strength bolts. The above mentioned structure ensures the stability of the crane jib transition structure and the strength of the overall jib.

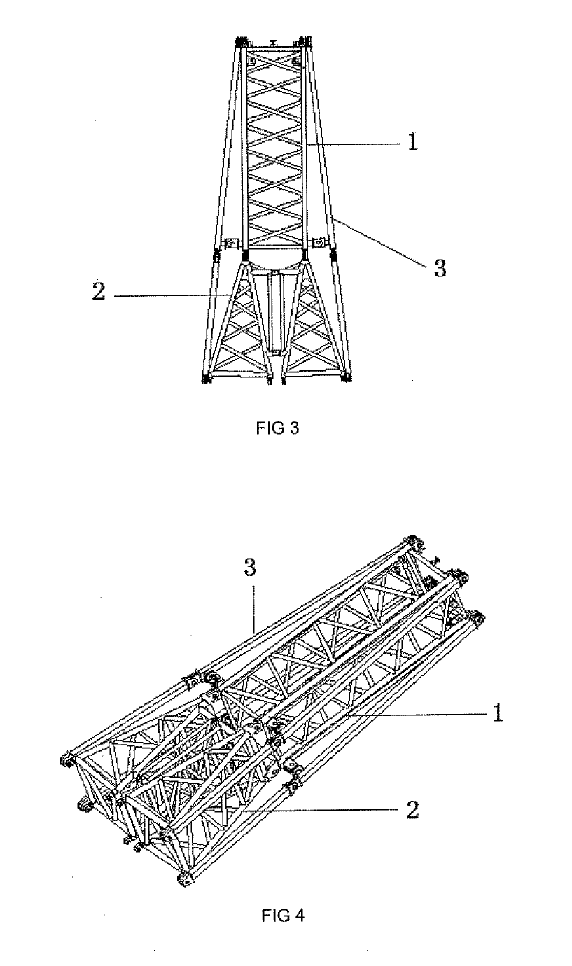

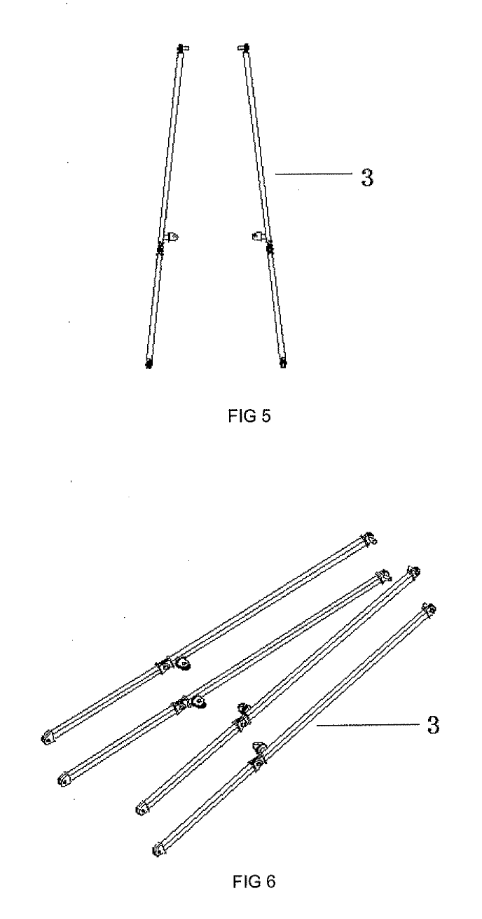

In the first preferred embodiment of the present invention, the supporting structure is a box beam. FIG. 3 and FIG. 4 shows the transition structure of the crane jib equipped with the box beam 3, the structure of the box beam 3 showed in FIG. 5 and FIG. 6. The figure shows the upper end of the box beam 3 fixedly connects to the upper end of the side of the jib section 1, the bottom end of the box beam 3 fixedly connects to the bottom end of the side of the transition section 2, the middle part of the box beam 3 fixedly connects to the connection point of the jib section 1 and the side of the transition section 2, which are in the corresponding side of the jib section 1 and transition section 2. Wherein the bearing pins used to connect can flexibly move on the box beam, thus which can connect to jib section 1 and transition section 2 at the right position, which can slow the change of the jib effectively, and ensure the stability and the strength of the overall jib.

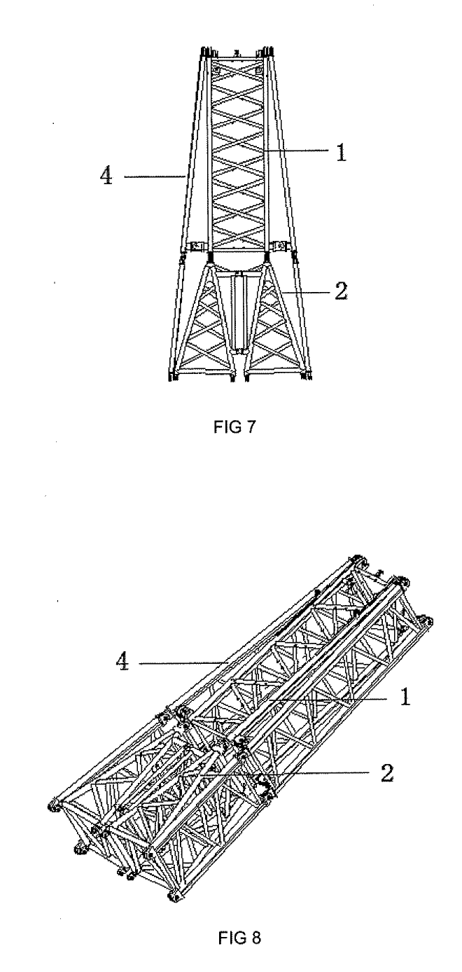

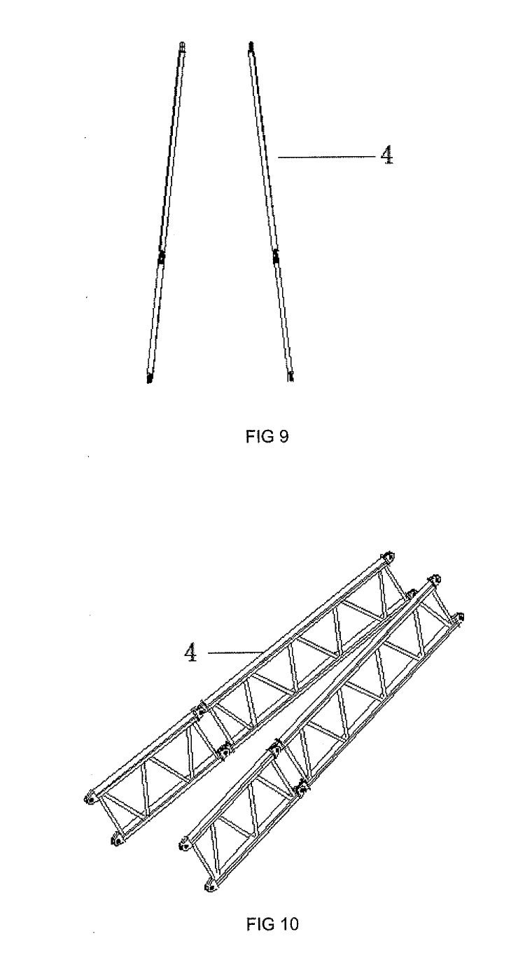

In the second preferred embodiment of the present invention, the supporting structure is a truss jib. FIG. 7 and FIG. 8 shows the transition structure of the crane jib equipped with the truss jib 4, the structure of the truss jib 4 is showed in FIG. 9 and FIG. 10. The figure shows the truss jib 4 is a trapezoid structure, which is equipped on the side surface of the jib section 1, the side surface is an outer side surface of jib section, including two adjacent sides. The upper end of the truss jib 4 connects to the upper end of the side surface, the bottom end of the truss jib 4 connects to the bottom end of the side surface of the transition section 2. The middle part of the truss jib 4 connects to the connection place of the side surface where the jib section 1 and the transition section 2 locates, Similarly, the bearing pins used to connect can flexibly move on the truss jib, thus which can connect to jib section and transition section at the right position. Using the above mentioned truss jib can slow the change of the crane jib effectively, and ensure the stability and the strength of the overall crane jib.

Therefore, the crane jib transition structure of the present invention can not only achieve the strength of the crane jib transition structure, but also achieve the strength and the overall stability of the crane jib, by using a supporting structure connecting to between the crane jib section and the transition section, which have simpler structure, easier installation, lower production cost and can be widely used in various types of cranes.

Although the above reference figures have been explained in accordance with the invention and the idea and embodiment of the purpose of the invention, the person of ordinary skill can recognize that, in the absence of claims from the premise of limited range of conditions, you can still make various improvements to the invention and transformation, which still belongs to the protection scope of the invention.

1. A crane jib transition structure, wherein, including a jib section, a transition section and a supporting structure, wherein, said jib section matches with said transition section, and they fixedly connect to each other, the upper end of said supporting structure fixedly connects to the upper end of the side of said jib section, the bottom end of said supporting structure fixedly connects to the bottom end of the corresponding side of the transition section, the middle part of said supporting structure fixedly connects to the connection part between the side of jib section and the corresponding side of transition section.

2. The crane jib transition structure according to claim 1, wherein, said supporting structure is a box beam and one box beam is positioned on each side of the corresponding jib section.

3. The crane jib transition structure according to claim 1, wherein, said supporting structure is a truss jib, and one truss jib is positioned on each side surface of the corresponding jib section, wherein said side surface is an outer side surface of jib section, including two adjacent sides.

4. The crane jib transition structure according to claim 3, wherein, said truss jib is a trapezoid structure.

5. The crane jib transition structure according to claim 1, wherein, said supporting structure is connected to said jib section by bearing pins or high-strength bolts.

6. The crane jib transition structure according to claim 1, wherein, said supporting structure is connected to said transition section by bearing pins or high-strength bolts.

7. The crane jib transition structure according to claim 1, wherein, said supporting structure is made up of steel pipe.

8. The crane jib transition structure according to claim 7, wherein, said steel pipe is a seamless steel pipe.
